(19) United States
(12) Patent Application Publication
(10) Pub. No.: US 2003/0053492 A1
(43) Pub. Date: Mar. 20, 2003

(54) Multiplexer, receiver, and multiplex transmission method

(76) Inventor: Osamu Matsunaga, Kanagawa (JP)

Correspondence Address: William S Frommer, Frommer Lawrence & Haug, 745 Fifth Avenue, New York, NY, 10151, US

(21) Appl. No.: 10/129,018

(22) PCT Filed: Sep. 3, 2001
(86) PCT No.: PCT/JP01/07617

(30) Foreign Application Priority Data
Sep. 1, 2000 (JP) 2000-269885

(51) Int. Cl. H04J 3/02

(52) U.S. Cl. 370/537

(57) ABSTRACT

The present invention relates to a multiplexing apparatus, a receiving apparatus, and a method of multiplex transmission. Specifically, a multiplexing apparatus which multiplexes a plurality of encoded data streams adds arrival time T1 as temporal information indicative of timing for suppling the encoded data streams to a plurality of decoding units of a receiver to a time-division-multiplexed data stream. The receiver decodes the encoded data streams on the basis of the arrival time T1. So, even though the transmission bands allocated to the respective data streams are varied, synchronization between original data streams and decoded data streams is secured without deleting part of information of the original data streams.

### TECHNICAL FIELD

The present invention relates to a multiplexing apparatus, a receiving apparatus, and a method of multiplex transmission, which are applicable to the television broadcasting employing digital broadcasting, commercial data transmission, etc. According to the present invention, temporal information indicative of timing for suppling a plurality of data streams to decoding units is added to a transmission data stream generated from the data streams, and the data streams are decoded on the basis of the temporal information. So, even though the transmission bands allocated to the respective data streams are varied, synchronization between original data streams and decoded data streams is secured without losing part of information of the original data streams.

### BACKGROUND ART

Conventionally, in the field of the television broadcasting employing digital broadcasting, a plurality of data streams each configures a television program to be served for television users are multiplexed and transmitted.

FIG. 7 shows a block diagram of a digital broadcasting system as a data transmission system. As shown, a digital broadcasting system 1 includes a transmission station 2, in which a multiplexing apparatus 4 multiplexes data streams SA to SC sent from encoding apparatuses 3A to 3C to generate a transmission data stream D1 as multiplexed data. Furthermore, the digital broadcasting system 1 includes a receiver 5 which receives the transmission data stream D1 transmitted from the transmission station 2 via a predetermined transmission line 6, in which a demultiplexing apparatus 7 demultiplexes the transmission data stream D1 to restore the original data streams SA to SC and sends the restored data streams SA to SC to decoding apparatuses 8A to 8C. In the receiver 5 shown in FIG. 7, the data streams SA to SC are sent to the decoding apparatuses 8A to 8C, respectively.

The encoding apparatuses 3A to 3C encode video data and audio data based on the format of such as the MPEG 2 (Moving Picture Experts Group 2) to generate the data streams SA to SC. The multiplexing apparatus 4 includes memories 9A to 9C being buffer memories which receive the data streams SA to SC, respectively. The memories 9A to 9C time-domain-compress, or compress in the time domain, retained data corresponding to the following processing of a multiplexing unit 10 arranged down stream, and send the time-domain-compressed data to the multiplexing unit 10.

The multiplexing unit 10 time-division-multiplexes, or multiplexes in the time divisional manner, the time-domain-compressed data sent from the memories 9A to 9C to generate and send the transmission data stream D1. In time-division-multiplexing the time-domain-compressed data, the multiplexing unit 10 packets output data of the memories 9A to 9C under the control of a multiplex controlling unit 11, and adds identification codes to respective packets so that the transmission data stream D1 can be demultiplexed to restore the original data streams SA to SC.

The transmission line 6 consists of a modulating apparatus for modulating the transmission data stream D1, a frequency-division-multiplexing apparatus for generating a frequency-division-multiplexed signal including other transmission data streams D1, various transmitting apparatuses, a tuner for receiving broadcasting radio signals transmitted from the transmitting apparatuses to obtain a desired broadcasting radio signal, and a demodulating apparatus for demodulating the output signal from the tuner to restore the transmission data stream D1.

In the receiver 5, the demultiplexing apparatus 7 receives thus received and demodulated transmission data stream D1, and controls memories 13A to 13C on the basis of the identification codes added to the respective packets to selectively record data of the respective packets constituting the transmission data stream D1 to corresponding memories 13A to 13C. Then, the memories 13A to 13C time-domain-expand, or expand in the time domain, thus recorded data, and send the restored data streams SA to SC to the decoding apparatuses 8A to 8C, respectively, in original transmission speed.

In the digital broadcasting system 1 in which the data streams SA to SC are thus transmitted, the memories 9A to 9C of the transmission station 2 are set to have a comparatively small capacity sufficient to mediate the respective data streams SA to SC in view of the multiplex processing by the multiplexing unit 10. Furthermore, in the digital broadcasting system 1, data of the state of the memories 9A to 9C arranged downstream following the encoding apparatuses 3A to 3C is added to corresponding packets and transmitted as control information, and timing for outputting decoded data from the decoding apparatuses 8A to 8C is controlled by the control information. Thus, synchronization is secured between the original video and audio data from which the respective data streams SA to SC are generated and resultant video and audio data which are sent from the decoding apparatuses 8A to 8C.

In the digital broadcasting system 1, transmission rates of the respective data streams SA to SC in the transmission data stream D1 are equal to those of the respective data streams SA to SC sent from the encoding apparatuses 3A to 3C. In case the sum of the transmission rates of the data streams SA to SC is within a transmission band of the transmission data stream D1, the data streams SA to SC sent from the encoding apparatuses 3A to 3C can be transmitted without any problem.

On the other hand, in case the encoding apparatuses 3A to 3C encode data based on the variable rate manner in which amount of codes to be generated is varied, and the data streams SA to SC generated based on the variable rate manner are multiplexed and transmitted, transmission bands to be allocated to the respective data streams SA to SC are inevitably varied. Thus, the sum of the transmission rates of the data streams SA to SC may not be within the transmission band of the transmission data stream D1. In this case, undesirably, the synchronization may not be secured between the original video and audio data and resultant video and audio data. Furthermore, amount of codes of the data streams SA to SC themselves to be generated may become large for such transmission bands. In this case, the same problem arises.

To cope with the problem, there is proposed a method in which amount of codes of the data streams SA to SC to be generated by the encoding apparatuses 3A to 3C are controlled using the rate controlling technique so that the sum of the transmission rates of the data streams SA to SC is within the transmission band of the transmission data stream D1. However, in this case, the multiplexing apparatus 4 is required to supply information necessary for the rate controlling to the encoding apparatuses 3A to 3C in real time so as to change amount of codes of the data streams SA to SC to be generated, which makes the configuration of the digital broadcasting system 1 complicated. Furthermore, in case the data streams SA to SC are supplied to the multiplexing apparatus 4 via a recording medium, etc., the processing itself becomes impossible.

On the other hand, there is proposed another method in which part of data of the data streams SA to SC is deleted so that the sum of the transmission rates of the data streams SA to SC is within the transmission band of the transmission data stream D1. However, in this case, part of information of the data streams SA to SC sent from the encoding apparatuses 3A to 3C has to be discarded.

### DISCLOSURE OF THE INVENTION

Accordingly, the present invention has an object to overcome the above-mentioned drawbacks of the prior art by providing a multiplexing apparatus, a receiving apparatus, and a method of multiplex transmission which can secure synchronization between original data streams and decoded data streams without deleting part of information of the original data streams even though the transmission bands to be allocated to the respective data streams are varied.

The above object can be attained by providing a multiplexing apparatus, including means for generating temporal information indicative of timing for suppling desired data streams constituting multiplexed data to decoding means, and means for adding the temporal information to the multiplexed data.

According to the multiplexing apparatus, the temporal information generating means comprises means for detecting arrival time of the desired data streams constituting the multiplexed data to multiplexer memories, and generates the temporal information using the arrival time detected by the arrival time detecting means.

Furthermore, the above object can be attained by providing a receiving apparatus, including means for controlling memories to control timing for suppling output data from the memories to decoding means on the basis of temporal information added to multiplexed data.

Furthermore, the above object can be attained by providing a method of multiplex transmission, wherein a transmission unit adds temporal information indicative of timing for suppling desired data streams constituting multiplexed data to decoding means to the multiplexed data, and transmits the multiplexed data, and a reception unit decodes the desired data streams generated from the transmitted multiplexed data on the basis of the temporal information.

According to the multiplexing apparatus of the present invention, since the multiplexing apparatus comprises means for generating temporal information indicative of timing for suppling desired data streams constituting multiplexed data to decoding means, and means for adding the temporal information to the multiplexed data, the respective data streams can be wholly multiplexed and transmitted. Furthermore, even though transmission time of the data streams, or periods which are required for the data streams to be transmitted, is varied due to variation of transmission bands allocated to the respective data streams or variation of amount of codes of the data streams themselves, the transmission time can be corrected and thus the respective data streams can be decoded. So, even though the transmission bands allocated to the respective data streams are varied, synchronization between original data streams and decoded data streams is secured without losing part of information of the original data streams.

According to the multiplexing apparatus of the present invention, since the temporal information generating means comprises means for detecting arrival time of the desired data streams constituting the multiplexed data to multiplexer memories, and generates the temporal information using the arrival time detected by the arrival time detecting means, the temporal information necessary for correcting the transmission time can be obtained easily.

According to the receiving apparatus of the present invention, since the receiving apparatus comprises means for controlling memories to control timing for suppling output data from the memories to decoding means on the basis of temporal information added to multiplexed data, even though the transmission bands allocated to the respective data streams are varied, synchronization between original data streams and decoded data streams is secured without losing part of information of the original data streams.

According to the method of multiplex transmission of the present invention, since a transmission unit adds temporal information indicative of timing for suppling desired data streams constituting multiplexed data to decoding means to the multiplexed data and transmits the multiplexed data, and a reception unit decodes the desired data streams generated from the transmitted multiplexed data on the basis of the temporal information, even though the transmission bands allocated to the respective data streams are varied, synchronization between original data streams and decoded data streams is secured without losing part of information of the original data streams.

### BRIEF DESCRIPTION OF THE DRAWINGS

FIG. 1 shows a block diagram of a first embodiment of the digital broadcasting system according to the present invention.

FIG. 2 shows a block diagram of a second embodiment of the digital broadcasting system according to the present invention.

FIG. 3 shows a block diagram of a third embodiment of the digital broadcasting system according to the present invention.

FIG. 4 shows a block diagram of a fourth embodiment of the digital broadcasting system according to the present invention.

FIG. 5 shows a block diagram of a fifth embodiment of the digital broadcasting system according to the present invention.

FIG. 6 shows a block diagram of a sixth embodiment of the digital broadcasting system according to the present invention.

FIG. 7 shows a block diagram of a conventional digital broadcasting system.

### BEST MODE FOR CARRYING OUT THE INVENTION

The present invention will further be described below concerning the best modes with reference to the accompanying drawings.

(1) First Embodiment

(1-1) Configuration of the First Embodiment

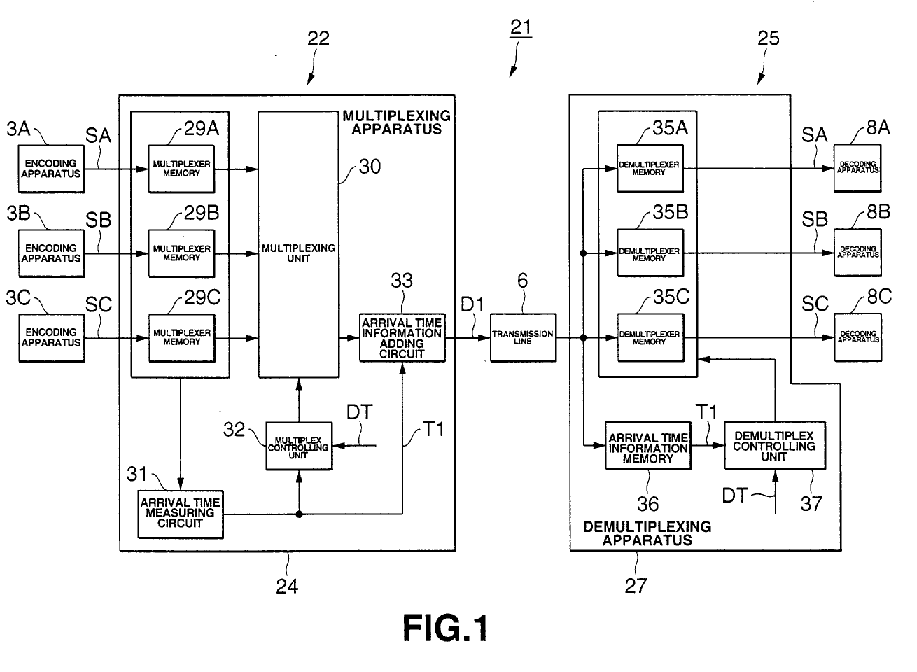

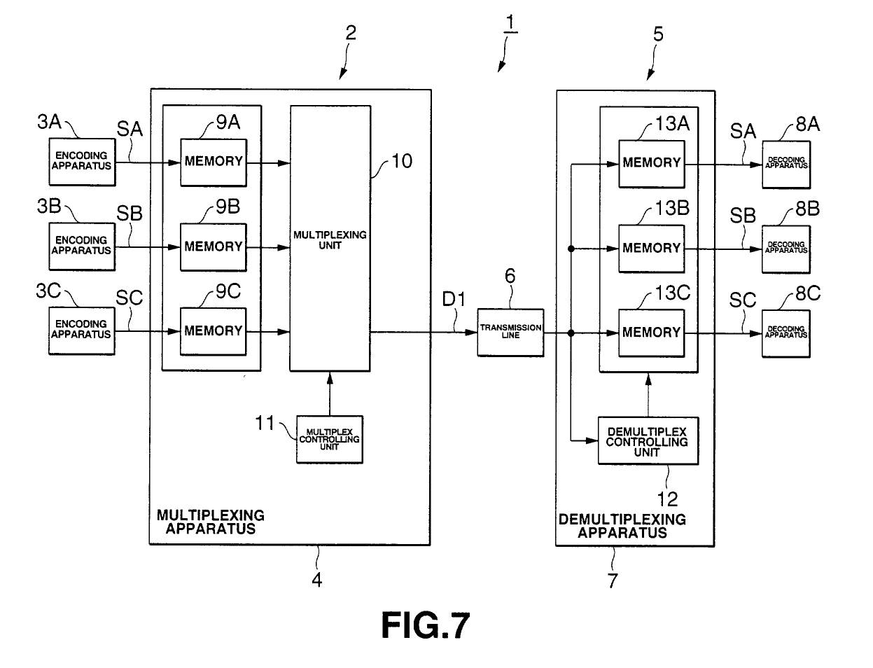

FIG. 1 shows a block diagram of a first embodiment of a digital broadcasting system according to the present invention. In a digital broadcasting system 21, the parts or components similar to those of the digital broadcasting system 1 shown in FIG. 7 are indicated with the same reference numerals, and duplicated explanation will be omitted.

As shown, the digital broadcasting system 21 includes a transmission station 22, in which a multiplexing apparatus 24 multiplexes data streams SA to SC and outputs a transmission data stream D1. The multiplexing apparatus 24 includes multiplexer memories 29A to 29C or memories adapted for multiplexing for temporarily retaining the data streams SA to SC sent from encoding apparatuses 3A to 3C and time-domain-compressing, or compressing in the time domain, the retained data streams SA to SC to output time-domain-compressed data corresponding to the following processing of a multiplexing unit 30 arranged down stream.

An arrival time measuring circuit 31 measures arrival time T1 which indicates time at which head portions of respective frames of video data included in the data streams SA to SC arrive at the respective multiplexer memories 29A to 29C on the basis of a reference clock, not shown. The arrival time measuring circuit 31 detects the head portions of respective frames of video data included in the data streams SA to SC by monitoring predetermined codes of the data streams SA to SC based on the format of the MPEG. Also, the arrival time measuring circuit 31 concurrently detects data amount of the data streams SA to SC and outputs data of the detection result.

A multiplexing unit 30 packets the time-domain-compressed data sent from the multiplexer memories 29A to 29C under the control of a multiplex controlling unit 32 to generate the transmission data stream D1. The multiplex controlling unit 32 settles transmission bands to be allocated to the respective data streams SA to SC corresponding to data amount of the respective data streams SA to SC, and controls the multiplexing unit 30 so that the data streams SA to SC are multiplexed under the settled transmission bands. Thus, in this embodiment, the multiplexing unit 30 and the multiplex controlling unit 32 configures a multiplexing unit which time-division-multiplexes, or multiplexes in the time divisional manner, the time-domain-compressed data sent from the multiplexer memories 29A to 29C to generate and send the transmission data stream D1. And the multiplexing unit varies transmission bands to be allocated to the respective data streams SA to SC corresponding to data amount of the data streams SA to SC of variable rate.

By thus performing the rate controlling, the multiplex controlling unit 32 varies the transmission bands to be allocated to the respective data streams SA to SC corresponding to data amount detected by the arrival time measuring circuit 31 to cause the multiplexing unit 30 to generate the transmission data stream D1. Also, the multiplex controlling unit 32 sets up repetition of packets of the respective data streams SA to SC corresponding to delay time DT which designates periods between time when the data streams SA to SC are sent to the multiplexer memories 29A to 29C and time when the data streams SA to SC are read out from demultiplexer memories 35A to 35C or memories adapted for demultiplexing. Thus, desired data streams SA to SC are continuously sent to a receiver 25. In this embodiment, the delay time DT is determined in advance.

Thus, memories of sufficiently large capacity which can cope with the variation of the transmission bands to be allocated to the respective data streams SA to SC and the variation of the transmission rates of the respective data streams SA to SC are arranged as the multiplexer memories 29A to 29C. So, when the multiplexing is performed, even though the transmission bands are varied corresponding to the transmission rates of the respective data streams SA to SC, data stored in the multiplexer memories 29A to 29C does not overflow.

So, the multiplexing apparatus 24 can transmit data without deleting part of information of original data streams even though the transmission bands to be allocated to the respective data streams are varied.

On the other hand, in case the data streams SA to SC are multiplexed in this manner, periods between time when the data streams SA to SC are sent from the encoding apparatuses 3A to 3C and time when the data streams SA to SC are transmitted to decoding apparatuses 8A to 8C as corresponding decoding units vary. So, in this embodiment, the arrival time T1 as temporal information indicative of timing for suppling the data streams SA to SC to the decoding apparatuses 8A to 8C as decoding units is added to the transmission data stream D1, and the variation of the transmission time of the data streams SA to SC, or periods which are required for the data streams SA to SC to be transmitted, is corrected by the temporal information.

That is, an arrival time information adding circuit 33 adds data indicative of the arrival time T1 to head portions of packets to which head portions of corresponding frames are assigned, and outputs the transmission data stream D1. Also, the multiplexing apparatus 24 sends controlling packets which sets up error correction information of the reference clock with a predetermined timing on the basis of the reference clock for performing data processing using the arrival time T1 measured on the basis of the reference clock. Thus, the multiplexing apparatus 24 can correct a reference clock of the receiver 25 on the basis of the controlling packets. So, the transmission station 22 and the receiver 25 can share the reference clock. Since, the reference clock is used by only the multiplexing apparatus 24 and a demultiplexing apparatus 27, a reference clock which is used for processing control information concerning transmission time between the encoding apparatuses 3A to 3C and the decoding apparatuses 8A to 8C may be used as the reference clock.

In the receiver 25, the demultiplexing apparatus 27 receives thus transmitted transmission data stream D1, and controls demultiplexer memories 35A to 35C on the basis of identification codes added to the respective packets to selectively record data of the respective packets constituting the transmission data stream D1 to corresponding demultiplexer memories 35A to 35C. Then, the demultiplexer memories 35A to 35C time-domain-expand, or expand in the time domain, thus recorded data, and send the restored data streams SA to SC to the decoding apparatuses 8A to 8C, respectively, in original transmission speed. Memories of comparatively large capacity are employed as the demultiplexer memories 35A to 35C so that data of the data streams SA to SC stored in the memories does not overflow even though multiplexing is performed by above-described rate controlling.

An arrival time information memory 36 selectively obtains information of the arrival time T1 added to the transmission data stream D1. A demultiplex controlling unit 37 controls reading out timing of the demultiplexer memories 35A to 35C so as to correct the transmission time on the basis of the sum of the arrival time T1 obtained by the arrival time information memory 36 and the delay time DT determined in advance.

(1-2) Operation of the First Embodiment

In the digital broadcasting system 21, the data streams SA to SC of video and audio data encoded and generated from the respective encoding apparatuses 3A to 3C are temporarily retained by the multiplexer memories 29A to 29C, and are then sequentially time-domain-compressed and output corresponding to the following processing of the multiplexing unit 30. Then, the time-domain-compressed data are packeted and time-division-multiplexed by the multiplexing unit 30, and the transmission data stream D1 is generated. In the digital broadcasting system 21, the transmission data stream D1 is transmitted to the receiver 25 via a transmission line 6 consisting of a frequency-division-multiplexing apparatus, transmitting apparatuses, a tuner, etc. Then, the packeted data of the respective data streams SA to SC are selectively sent to the demultiplexer memories 35A to 35C of the receiver 25, and the data streams received by the demultiplexer memories 35A to 35C are decoded by the decoding apparatuses 8A to 8C. Thus, in the digital broadcasting system 21, the data streams SA to SC are time-division-multiplexed and transmitted, and are then received and monitored by the receiver 25.

In the digital broadcasting system 21, these data streams SA to SC are generated by the encoding apparatuses 3A to 3C based on the encoding processing conforming to the MPEG 2. Then, the control information for controlling the processing of the decoding apparatuses 8A to 8C is added to the transmission data stream D1. And then, the original video and audio data is decoded by the decoding apparatuses 8A to 8C on the basis of the control information.

In the digital broadcasting system 21, since the control information is transmitted and the delay time which designates periods between time when the data streams SA to SC are sent from the encoding apparatuses 3A to 3C and time when the data streams SA to SC are sent to the decoding apparatuses 8A to 8C is secured, that is the respective data streams SA to SC are so supplied to the decoding apparatuses 8A to 8C as to correspond to the processing thereof, synchronization between input data streams of the encoding apparatuses 3A to 3C and output data streams of the decoding apparatuses 8A to 8C is secured.

On the other hand, in the digital broadcasting system 21, since the encoding processing of the encoding apparatuses 3A to 3C is performed based on the format of the MPEG 2, amount of codes of the data streams SA to SC resulting from the encoding processing varies corresponding to original video data. Thus, the transmission rates of the respective data streams SA to SC vary. So, in case the transmission rates increase in proportion to the transmission bands allocated to the data streams SA to SC, data to be temporarily retained by the multiplexer memories 29A to 29C increases, which causes periods during which the data streams SA to SC are retained by the multiplexer memories 29A to 29C to be extended. Accordingly, timing for suppling the data streams SA to SC to the decoding apparatuses 8A to 8C is delayed. Furthermore, data of the data streams SA to SC to be stored in the multiplexer memories 29A to 29C may overflow.

For this reason, in the digital broadcasting system 21, in performing multiplexing, data amount of the respective data streams SA to SC is measured by the arrival time measuring circuit 31, and the multiplex controlling unit 32 performs the rate controlling on the basis of the measured data amount so as to settle the transmission bands so that the settled transmission bands correspond to the transmission rates of the respective data streams SA to SC. Thus, in the digital broadcasting system 21, the transmission bands of the data streams SA to SC vary due to variation of transmission rates of other data streams SA to SC. In the digital broadcasting system 1, the capacity of the multiplexer memories 29A to 29C is set up so that data of the data streams SA to SC stored in the memories does not overflow in performing such data controlling. So, by allocating the transmission bands in accordance with the data amount of the respective data streams SA to SC, loss of data can be effectively prevented.

In the digital broadcasting system 21, periods between time when the data streams SA to SC are sent from the multiplexer memories 29A to 29C and time when the data streams SA to SC are sent to the demultiplexer memories 35A to 35C vary. Thus, the condition of synchronization between input data streams of the encoding apparatuses 3A to 3C and output data streams of the decoding apparatuses 8A to 8C may not be satisfied. That is, it may not be satisfied that the delay time which designates periods between time when the data streams SA to SC are sent from the encoding apparatuses 3A to 3C and time when the data streams SA to SC are sent to the decoding apparatuses 8A to 8C is secured, or the respective data streams SA to SC are so supplied to the decoding apparatuses 8A to 8C as to correspond to the processing thereof.

So, according to the present invention, in the arrival time measuring circuit 31, arrival time T1 to the multiplexer memories 29A to 29C is detected on the basis of the head portions of frames of video data assigned to the respective data streams SA to SC. Furthermore, the arrival time T1 is added to head portions of packets to which head portions of corresponding frames are assigned, which packets are of corresponding data streams. Furthermore, thus added arrival time T1 is selectively obtained by the arrival time information memory 36, and reading out timing of the demultiplexer memories 35A to 35C is set up using the sum of the arrival time T1 and the delay time DT so that variation of the transmission time which varies due to the rate controlling performed by the multiplex controlling unit 32 is corrected. Thus, in the digital broadcasting system 1, even though the transmission bands allocated to the respective data streams SA to SC are varied, the delay time which designates periods between time when the data streams SA to SC are sent from the encoding apparatuses 3A to 3C and time when the data streams SA to SC are sent to the decoding apparatuses 8A to 8C is secured. So, synchronization between original data streams and decoded data streams is secured without deleting part of information of the original data streams.

(1-3) Effect of the First Embodiment

As in the above, temporal information indicative of timing for suppling a plurality of data streams to decoding units is added to a transmission data stream generated from the data streams, and the data streams are decoded on the basis of the temporal information. So, even though transmission bands allocated to the respective data streams are varied, synchronization between original data streams and decoded data streams is secured without deleting part of information of the original data streams.

Since the temporal information is generated using arrival time of the data streams to the multiplexer memories, such temporal information can be obtained easily without a difficult configuration.

That is, the arrival time of the data streams of video data and audio data encoded based on the variable rate manner is measured on the basis of starting points of frames of the video data, the arrival time can be surely detected easily.

Furthermore, since the temporal information is arranged at head portions of corresponding data groups of the multiplexed data, continuous data streams can be surely processed corresponding to variation of data amount on the basis of frame unit.

Thus, in this embodiment, transmission bands to be allocated to the respective data streams are varied corresponding to data amount of the respective data streams to generate the multiplexed data. So, synchronization between original data streams and decoded data streams is secured without deleting part of information of the original data streams.

(2) Second Embodiment

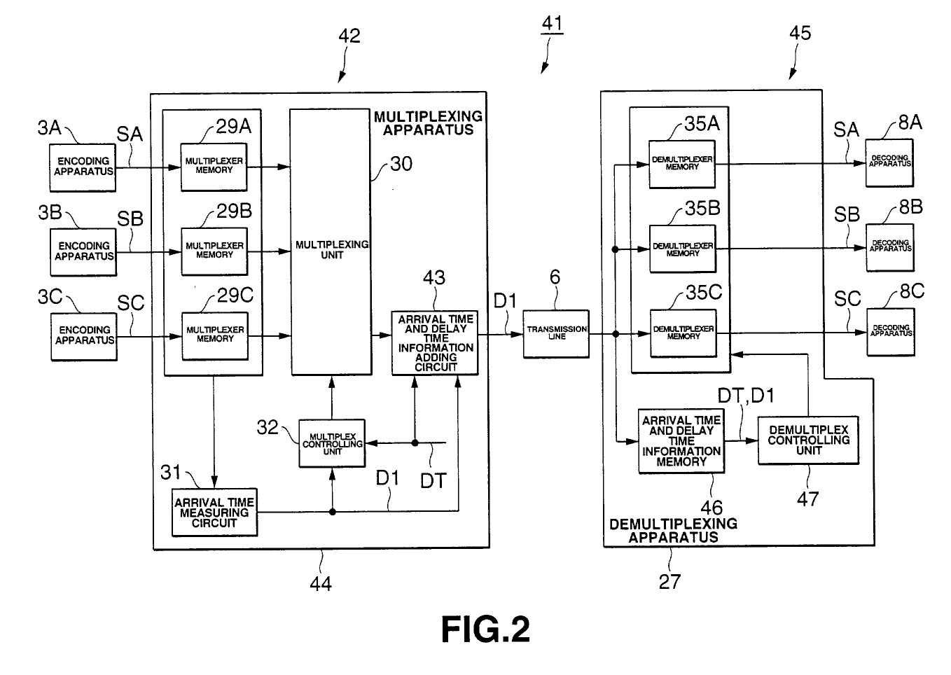

FIG. 2 shows a block diagram of a second embodiment of a digital broadcasting system according to the present invention. In a digital broadcasting system 41, the parts or components similar to those of the digital broadcasting system 21 shown in FIG. 1 are indicated with the same reference numerals, and duplicated explanation will be omitted.

As shown, the digital broadcasting system 41 includes a transmission station 42, in which an arrival time and delay time information adding circuit 43 adds temporal information consisting of information of the arrival time T1 and information of the delay time DT to the transmission data stream D1, and transmits the transmission data stream D1. At this time, a multiplexing apparatus 44 accepts setting up of the delay time DT for respective data streams SA to SC. The arrival time and delay time information adding circuit 43 adds the temporal information to head portions of packets to which head portions of frames are assigned among packets of corresponding data streams, and transmits the transmission data stream D1.

On the other hand, the digital broadcasting system 41 includes a receiver 45, in which an arrival time and delay time information memory 46 extracts the information of the arrival time T1 and the information of the delay time DT from the transmission data stream D1, and sends thus extracted information to a demultiplex controlling unit 47. The demultiplex controlling unit 47 adds the delay time DT to the arrival time T1 to determine reference time for reading out the data streams SA to SC, and controls timing for reading out the data streams SA to SC by the demultiplexer memories 35A to 35C on the basis of the reference time. Thus, in the digital broadcasting system 21, even though the transmission bands allocated to the respective data streams SA to SC are varied, synchronization between original data streams and decoded data streams is secured without deleting part of information of the original data streams. Furthermore, timing for decoding among the data streams SA to SC can be relatively corrected by designating the delay time DT.

(3) Third Embodiment

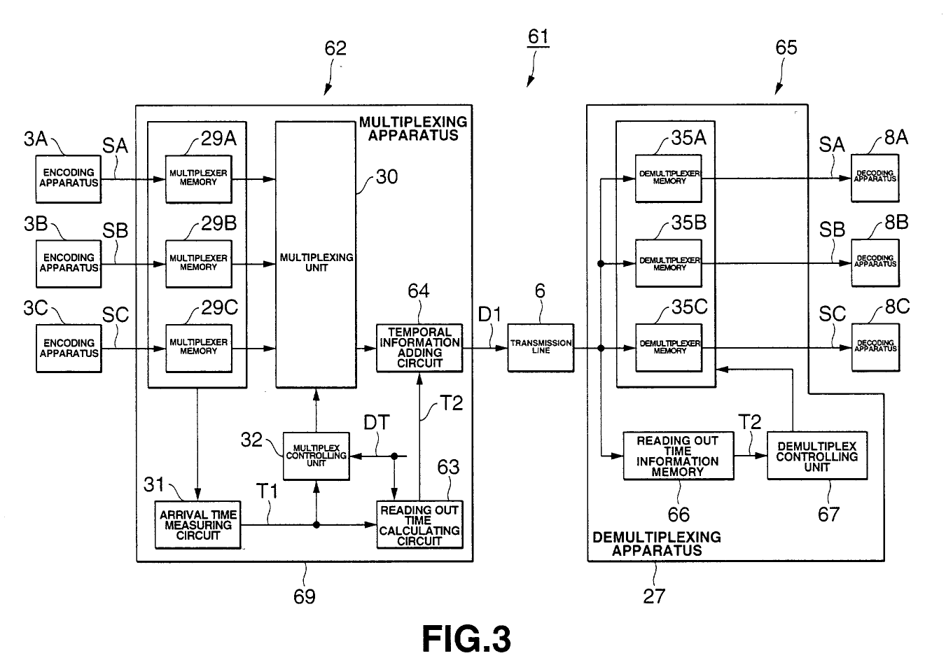

FIG. 3 shows a block diagram of a third embodiment of a digital broadcasting system according to the present invention. In a digital broadcasting system 61, the parts or components similar to those of the digital broadcasting system 21 shown in FIG. 1 are indicated with the same reference numerals, and duplicated explanation will be omitted.

As shown, the digital broadcasting system 61 includes a transmission station 62, in which a reading out time calculating circuit 63 adds the delay time DT to the arrival time T1, and generates reading out time T2 indicative of timing for reading out the data streams SA to SC by the demultiplexer memories 35A to 35C for respective data streams SA to SC directly from the resulting data. A temporal information adding circuit 64 adds the information of the reading out time T2 to bead portions of packets to which head portions of frames are assigned among packets of corresponding data streams, and transmits the transmission data stream D1.

On the other hand, the digital broadcasting system 61 includes a receiver 65, in which a reading out time information memory 66 extracts the information of the reading out time T2 from the transmission data stream D1, and sends thus extracted information to a demultiplex controlling unit 67. The demultiplex controlling unit 67 controls timing for reading out the data streams SA to SC by the demultiplexer memories 35A to 35C on the basis of the reading out time T2. Thus, in the digital broadcasting system 61, the transmission station 62 has the function of the receiver 25 and receiver 45 of the first embodiment and second embodiment, and even though the transmission bands allocated to the respective data streams SA to SC are varied, synchronization between original data streams and decoded data streams is secured without deleting part of information of the original data streams. Furthermore, timing for decoding among the data streams SA to SC can be relatively corrected by designating the delay time DT.

According to the third embodiment, since the temporal information is generated using the arrival time and the transmission time, which designates periods between time when the data streams are sent to the corresponding multiplexer memories and time when the data streams are sent to the decoding means, the configuration of the receiver can be simplified and the same effect as the second embodiment can be obtained.

(4) Fourth Embodiment

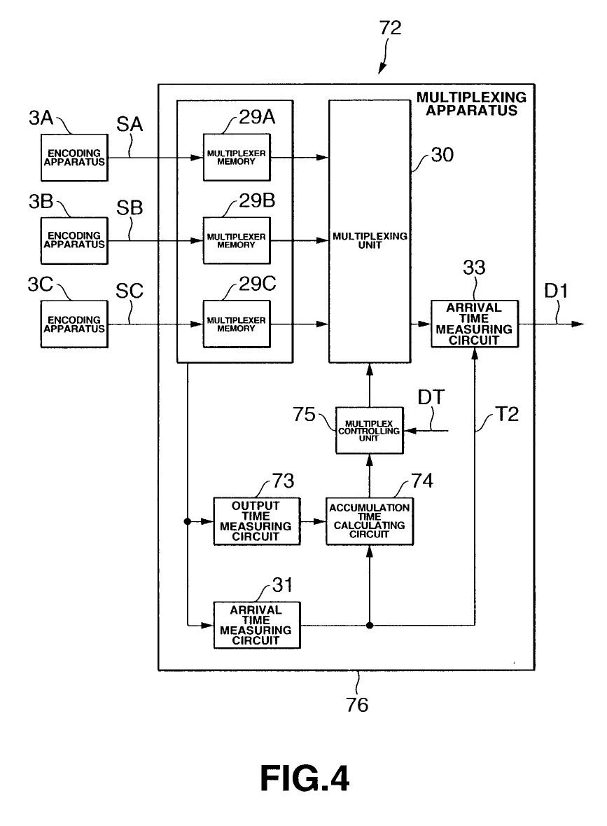

FIG. 4 shows a block diagram of a fourth embodiment of a digital broadcasting system according to the present invention contrasted with FIG. 1, in which only a transmission station is shown. That is, the digital broadcasting system of the fourth embodiment replaces the transmission station 22 shown in FIG. 1 with a transmission station 72. In FIG. 4, the parts or components similar to those shown in FIG. 1 are indicated with the same reference numerals, and duplicated explanation will be omitted.

In the transmission station 72, corresponding to the arrival time T1 measured at the arrival time measuring circuit 31, an output time measuring circuit 73 measures output time at which the time-domain-compressed data is sent from the corresponding multiplexer memories 29A to 29C. An accumulation time calculating circuit 74 calculates accumulation time or periods during which the respective data streams SA to SC are temporarily retained by the multiplexer memories 29A to 29C using the arrival time T1 and thus measured output time.

The multiplex controlling unit 75 determines data amount of the respective data streams SA to SC using the accumulation time, and settles transmission bands to be allocated to the respective data streams SA to SC using the determination result, and controls the multiplexing unit 30 so that the data streams SA to SC are multiplexed under the settled transmission bands. Due to the operation of the multiplex controlling unit 75, the data streams SA to SC are surely sent to the decoding apparatuses 8A to 8C of the receiver 25 under the above-described delay time.

According to the fourth embodiment, since the time-domain-compressed data sent from the multiplexer memories is time-division-multiplexed such that periods during which the respective data streams are temporarily retained by the multiplexer memories are not longer than a predetermined period. So, synchronization between original data streams and decoded data streams is surely secured without deleting part of information of the original data streams as compared with the first embodiment.

(5) Fifth Embodiment

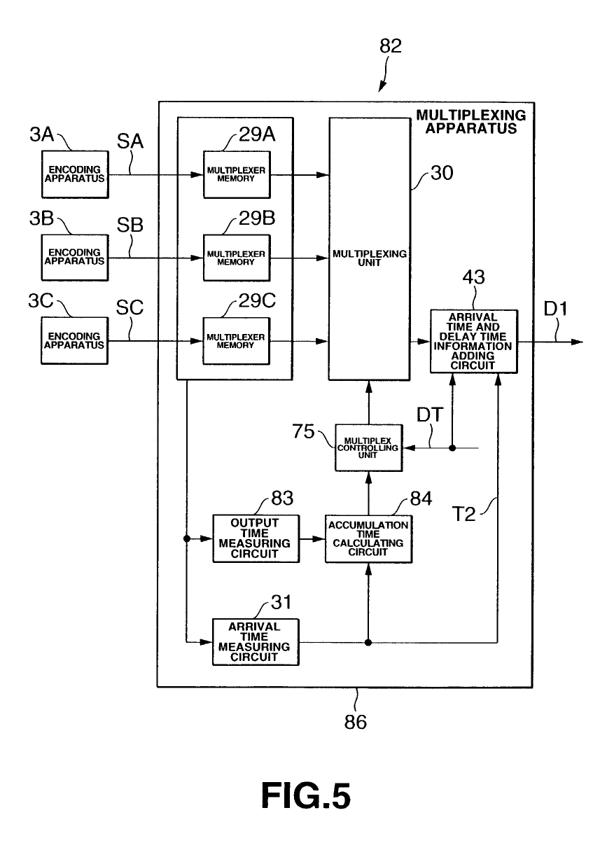

FIG. 5 shows a block diagram of a fifth embodiment of a digital broadcasting system according to the present invention contrasted with FIG. 2 and FIG. 4, in which only a transmission station is shown. That is, the digital broadcasting system of the fifth embodiment replaces the transmission station 42 shown in FIG. 2 with a transmission station 82. In FIG. 5, the parts or components similar to those shown in FIG. 2 and FIG. 4 are indicated with the same reference numerals, and duplicated explanation will be omitted.

Also, in the transmission station 82, corresponding to the arrival time T1 measured at the arrival time measuring circuit 31, the output time measuring circuit 73 measures output time at which the time-domain-compressed data is sent from the corresponding multiplexer memories 29A to 29C. Then, the accumulation time calculating circuit 74 calculates accumulation time or periods during which the respective data streams SA to SC are temporarily retained by the multiplexer memories 29A to 29C using the arrival time T1 and thus measured output time. Furthermore, the multiplex controlling unit 75 determines data amount of the respective data streams SA to SC using the accumulation time, and settles transmission bands to be allocated to the respective data streams SA to SC using the determination result, and controls the multiplexing unit 30 so that the data streams SA to SC are multiplexed under the settled transmission bands. Due to the operation of the multiplex controlling unit 75, the data streams SA to SC are surely sent to the decoding apparatuses 8A to 8C of the receiver 25 under the above-described delay time.

According to the fifth embodiment, synchronization between original data streams and decoded data streams is surely secured without deleting part of information of the original data streams as compared with the second embodiment.

(6) Sixth Embodiment

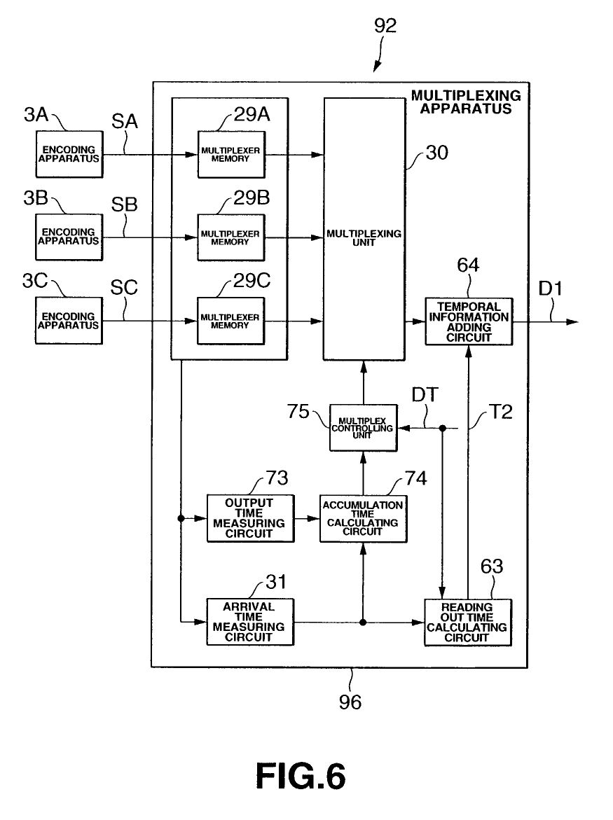

FIG. 6 shows a block diagram of a sixth embodiment of a digital broadcasting system according to the present invention contrasted with FIG. 3 and FIG. 4, in which only a transmission station is shown. That is, the digital broadcasting system of the sixth embodiment replaces the transmission station 62 shown in FIG. 3 with a transmission station 92. In FIG. 6, the parts or components similar to those shown in FIG. 3 and FIG. 4 are indicated with the same reference numerals, and duplicated explanation will be omitted.

Also, in the transmission station 92, corresponding to the arrival time T1 measured at the arrival time measuring circuit 31, the output time measuring circuit 73 measures output time at which the time-domain-compressed data is sent from the corresponding multiplexer memories 29A to 29C. Then, the accumulation time calculating circuit 74 calculates accumulation time or periods during which the respective data streams SA to SC are temporarily retained by the multiplexer memories 29A to 29C using the arrival time T1 and thus measured output time. Furthermore, the multiplex controlling unit 75 determines data amount of the respective data streams SA to SC using the accumulation time, and settles transmission bands to be allocated to the respective data streams SA to SC using the determination result, and controls the multiplexing unit 30 so that the data streams SA to SC are multiplexed under the settled transmission bands. Due to the operation of the multiplex controlling unit 75, the data streams SA to SC are surely sent to the decoding apparatuses 8A to 8C of the receiver 25 under the above-described delay time.

According to the sixth embodiment, synchronization between original data streams and decoded data streams is surely secured without deleting part of information of the original data streams as compared with the third embodiment.

(7) Seventh Embodiment

In the above-described embodiments, the respective data streams are processed by the decoding apparatuses. On the other hand, the present invention is not limited to these embodiments, and is widely applicable to cases in which single data stream is selectively decoded and processed. In these cases, single demultiplexer memory is employed, and a desired data stream can be demultiplexed from the transmission data stream by selectively outputting data from the demultiplexer memory on the basis of identification data set up for respective packets, or by selectively recording data to the demultiplexer memory.

In the above-described embodiments, three data streams are time-division-multiplexed to be transmitted. On the other hand, the present invention is not limited to these embodiments, and is widely applicable to cases in which a plurality of data streams other than three data streams are time-division-multiplexed to be transmitted.

In the above-described embodiments, three data streams of video data and audio data are time-division-multiplexed to be transmitted. On the other hand, the present invention is not limited to these embodiments, and is widely applicable to cases in which data streams for data broadcasting or data streams for music broadcasting are time-division-multiplexed to be transmitted. In these cases, in case synchronization between original data streams and decoded data streams is required, such synchronization can be obtained by transmitting temporal information similar to above-described embodiments.

In the above-described embodiments, the present invention is applied to the digital broadcasting systems. On the other hand, the present invention is not limited to such digital broadcasting systems, and is widely applicable to cases adapted for commercial data transmission of above-described data.

Industrial Applicability

As in the above, according to the present invention, temporal information indicative of timing for suppling a plurality of data streams to decoding units is added to a transmission data stream generated from the data streams, and the data streams are decoded on the basis of the temporal information. So, even though the transmission bands allocated to the respective data streams are varied, synchronization between original data streams and decoded data streams is secured without losing part of information of the original data streams.

1. A multiplexing apparatus for multiplexing a plurality of data streams and outputting multiplexed data, comprising:
a plurality of multiplexer memories for temporarily retaining the data streams correspondingly, and time-domain-compressing the retained data streams to output time-domain-compressed data;
means for time-division-multiplexing the time-domain-compressed data sent from the multiplexer memories to generate the multiplexed data;
means for generating temporal information indicative of timing for suppling the data streams constituting the multiplexed data to decoding means; and
means for adding the temporal information to the multiplexed data.

2. The multiplexing apparatus as set forth in claim 1, wherein the temporal information generating means comprises means for detecting arrival time of the desired data streams constituting the multiplexed data to the multiplexer memories, and generates the temporal information using the arrival time detected by the arrival time detecting means.

3. The multiplexing apparatus as set forth in claim 2, wherein the temporal information generating means generates the temporal information using the arrival time and transmission time which designates periods between time when the data streams are sent to the corresponding multiplexer memories and time when the data streams are sent to the decoding means.

4. The multiplexing apparatus as set forth in claim 2, wherein the temporal information generating means generates the temporal information by adding the transmission time, which designates periods between time when the data streams are sent to the corresponding multiplexer memories and time when the data streams are sent to the decoding means, to the arrival time.

5. The multiplexing apparatus as set forth in claim 2, wherein the data streams include video data which is encoded based on the variable rate manner,
and the temporal information generating means generates the temporal information on the basis of starting points of frames or starting points of fields of the video data.

6. The multiplexing apparatus as set forth in claim 1, wherein the temporal information adding means arranges the temporal information at head portions of corresponding data groups of the multiplexed data.

7. The multiplexing apparatus as set forth in claim 1, wherein, in generating the multiplexed data, the time-division-multiplexing means varies transmission bands to be allocated to the respective data streams corresponding to data amount of the respective data streams.

8. The multiplexing apparatus as set forth in claim 1, wherein the time-division-multiplexing means time-division-multiplexes the time-domain-compressed data sent from the multiplexer memories such that periods during which the data streams are temporarily retained by the multiplexer memories are not longer than a predetermined period.

9. A receiving apparatus for receiving multiplexed data generated by time-division-multiplexing a plurality of data streams and decoding the data streams, comprising:
memories for receiving the multiplexed data and selectively outputting data constituting the desired data streams;
means for decoding the output data sent from the memories and outputting the desired decoded data streams; and
means for controlling the memories to control timing for suppling the output data from the memories to the decoding means on the basis of temporal information added to the multiplexed data.

10. The receiving apparatus as set forth in claim 9, wherein the temporal information is input time information of the data streams to memories adapted for time-division-multiplexing the data streams.

11. The receiving apparatus as set forth in claim 9, wherein the temporal information is input time information of the data streams to memories adapted for time-division-multiplexing the data streams, and transmission time which designates periods between time when the data streams are sent to corresponding memories adapted for time-division-multiplexingthe data streams and time when the data streams are sent to the decoding means.

12. The receiving apparatus as set forth in claim 9, wherein the temporal information is generated by adding transmission time which designates periods between time when the data streams are sent to corresponding memories adapted for time-division-multiplexing the data streams and time when the data streams are sent to the decoding means to input time information of the data streams to memories adapted for time-division-multiplexing the data streams.

13. The receiving apparatus as set forth in claim 9, wherein the memory-controlling means obtains the temporal information from head portions of corresponding data groups of the multiplexed data.

14. A method of multiplex transmission for multiplexing a plurality of data streams and transmitting multiplexed data, wherein
a transmission unit adds temporal information indicative of timing for suppling the desired data streams constituting the multiplexed data to decoding means to the multiplexed data, and transmits the multiplexed data, and
a reception unit decodes the desired data streams generated from the transmitted multiplexed data on the basis of the temporal information.

15. The method of multiplex transmission as set forth in claim 14, wherein
at the transmission unit, multiplexer memories time-domain-compress the data streams to generate the multiplexed data, and the temporal information is generated using arrival time of the data streams to the multiplexer memories, and
at the reception unit, memories receive the multiplexed data and the desired data streams from the memories are selectively output and decoded, and timing for outputting data from the memories are controlled on the basis of the temporal information.
